(19) United States
(12) Patent Application Publication
(10) Pub. No.: US 2014/0379683 A1
(43) Pub. Date: Dec. 25, 2014

(54) SEARCH ENGINE INTERFACES AND FUNCTIONS

(71) Applicant: GAURAV BAZAZ, EDGEWATER, NJ (US)

(72) Inventor: GAURAV BAZAZ, EDGEWATER, NJ (US)

(21) Appl. No.: 14/311,347

(22) Filed: Jun. 23, 2014

Related U.S. Application Data
(60) Provisional application No. 61/838,322, filed on Jun. 23, 2013.

(51) Int. Cl. G06F 17/30

(52) U.S. Cl. CPC G06F 17/30867
USPC 707/706; 707/723

(57) ABSTRACT

We propose interface and functional improvements for conventional web search engines. The proposed improvements can considerably improve the user experience and help users achieve their information search objective much faster and more efficiently.

### RELATED APPLICATION

This application claims the benefit of priority to U.S. Provisional Application 61/838,322 filed 23 Jun. 2013, the entire disclosure of which is incorporated by reference.

### BACKGROUND

Search engines are used daily by millions of people to look for information on the World Wide Web (WWW). The interface usually consists of a simple text entry form where the user enters the search query as text and receives a series of hyperlinks that link to documents on the WWW which are relevant to the search query. The user interaction with the search engine is generally limited to entering the search text and clicking on the served links to reach the desired documents.

### SUMMARY OF INVENTION

A search engine interface element is proposed that provides deeper information about each result hyperlink (Target) to the user on the Search Engine Results Page (SERP). The user interface (UI) element provides much deeper and relevant contextual information so as to help the user decide very quickly if the given webpage, website or document is relevant to the user. While some existing search engines provide a snapshot view of the Target, the present invention proposes a model where metadata about the Target is presented to the user instead. The metadata presented may be items such as: unusual words and phrases, highest frequency words, technical terms used, snapshots of images and data tables on the target, major sites linking to the given page, frequency of search query text in the Target page, type of site (academic, commercial, news etc.), major headers in the page (<H1> tags) etc.

This is distinct from conventional snapshot UI elements on SERPs where a cached image of the Target page is usually shown to the user as a preview. In this model, analytical information about the Target page is presented instead in a standardized model so different Target links can be easily compared and the summary of their content be easily distinguished prior to visiting the page itself.

In another innovation, a search engine interface element is proposed that displays the rankings of the target page on various criteria. The UI element will display information such as the rating of Target page in terms of text relevance, link quality, language quality, breadth of information related to given search term, reputation of domain or associated domain etc. The element may also display the search keywords/terms for which the page ranks very high when those search keywords are searched for on the search engine.

A search engine method is proposed for navigational searching. A majority of search queries run on search engines are simply searches for the URL of the site the user wants to access. In other words, the searches are not for acquiring information or knowledge, but purely intended to help the person navigate to a particular site the user already has in mind. We propose a method whereby when the user runs a navigational search, as determined by an algorithm in the search engine, the search engine directly takes the user to the target site without showing the SERP. In another model, the search engine displays the SERP for short period of time, after which the user is automatically navigated to the first Target result site without any user intervention. This allows the user to choose another possible destination, but if user does not choose another destination by clicking one of the Target links, he is automatically navigated to the first Target results site.

In each of the above innovations, the UI element may be directly displayed or display upon a user action such as hovering over a Target. The specific design of the UI element may vary considerably, but it displays the above defined information, and is available for display on the SERP itself.

### DESCRIPTION OF DRAWINGS

FIG. 1 shows the interface for a search engine with a summarization block for the first results page displayed. The search engine 001 has a logo block at the top left 002. The search term is entered into the textbox at 004. The user can run the search query by clicking the button 003. As a result a series of results hyperlinks (Targets) 006 are generated on the screen including the top result 005. When the user cursor or pointer hovers over a results link such as 005, a summarization block is displayed which shows summary information about the Target 005. In the present case, when the user pointer hovers above the result 005, summarization block 007 is displayed next to it. The summarization block 007 carries various items of information that describe various relevant details about the results page which can help the user understand the contents and nature of the page before clicking through to the page and reading through it. The summarization block 007 may have a header 009 which indicates the nature of the graphical block 007. Below the header, some high level information 008, such as the frequency of the search term and type of site, may be displayed. Another block of text 011 shows unusual words or phrases found on the page or site. Another block 013 shows other phrases and terms on the page which are similar to the search term. Block 016 shows a list of terms which have been defined on the page. The block 018 shows a list of major headings within the results page. Block 020 shows a list of major sites that link to this webpage or website and list of major sites that the page links to. The next block 022 shows a thumbnail gallery of some of the images on the site. Finally, the block 024 shows a list of tables on the webpage. The description here forms only one among many possible embodiments of the current innovation, without departing from the scope of the invention. While more or fewer blocks of information may be added, the underlying invention is the concept of breaking up the information in a results page by categories, and adding metadata and analytical data about the page and site and displaying that information in summary rather than a simple snapshot of the webpage. This model provides the user much more useful and efficient perspective of the results pages than a preview snapshot does.

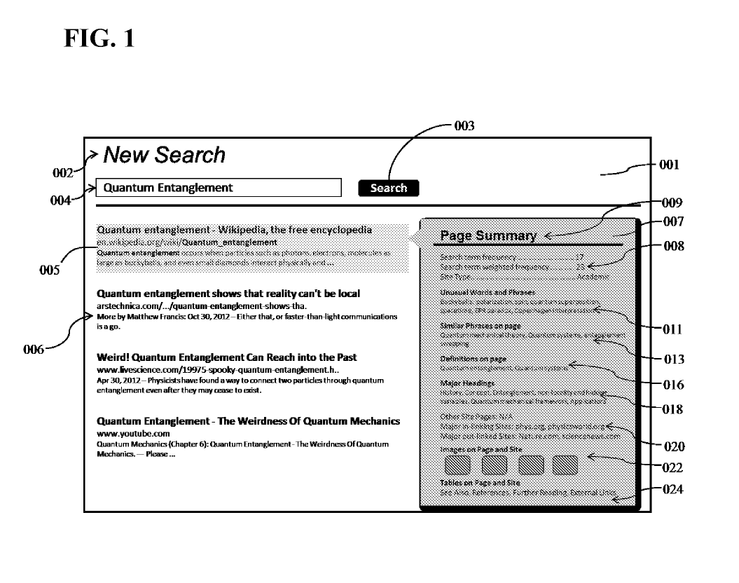

FIG. 2 shows the same search engine 001. However, the summarization block 007 is replaced with a Rankings Summary block 025. This block displays the rankings of the results page on various different criteria. For instance, the ranking of the page in terms of its keyword quality, relevancy of the text on the page to the search term, quality of links into the site, freshness of the page and other such items is presented in the text block 027. The information included in block 025 may also be included in block 007 in FIG. 1, in another embodiment. Additionally, the user may switch between the different types of summarization blocks, such as 007 and 025, using some interface element, such as a toggle button, provided by the search engine. Finally, a search engine may offer only one of the two types of summarization blocks, and not both, as well.

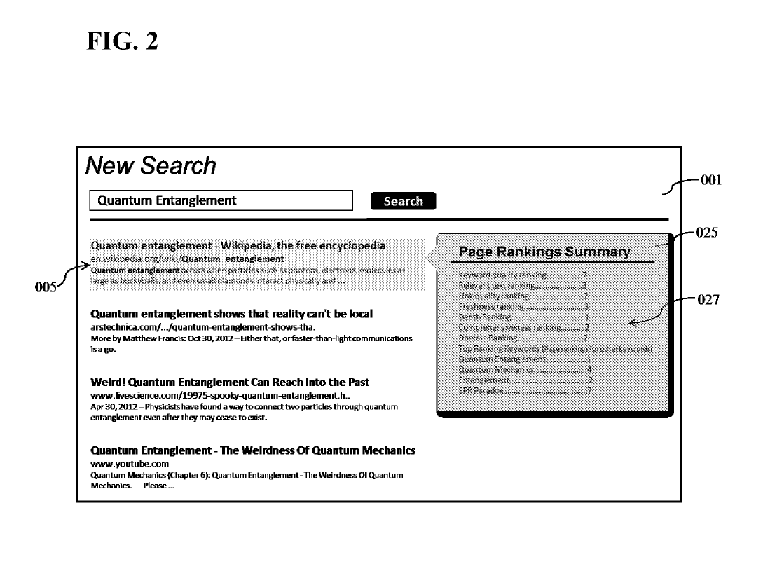

FIG. 3 shows the difference between conventional navigational search and navigational search as described in current invention. In FIG. 3 section (a), the process flow describes how navigational search works in conventional search engines. The process starts at 028. The user enters his search term at 030. The search engine displays a series of results for the search term at 032, including the site which the user intended to go to. The user clicks the link for the site that he intended to navigate to at 034 and leaves the search site. In FIG. 3 section (b), the flow for the current invention is described. The process starts at 035. The user enters the search term at 037. The search engine using an algorithm checks if the search term entered qualifies as a navigational search query or not at 039. A navigational search would be a case where the user enters the name of a website with the intention of navigating to that site alone and is not interested in multiple search results, but only one. In other words, the user is unsure of the exact web address and enters the name of the site to get the full web address. In other cases the user may enter the site name so as to save the trouble of entering the full name with domain name into the address bar of the browser. In all navigational search cases, the user intent is to navigate to a specific site that the user already has in mind. If the system determines that the search is not navigational the engine generates a set of search results on the results page at 040. However, if the search engine determines that the search is a navigational search, the search engine automatically redirects the user to the intended site at 038 and does not generate a search results page.

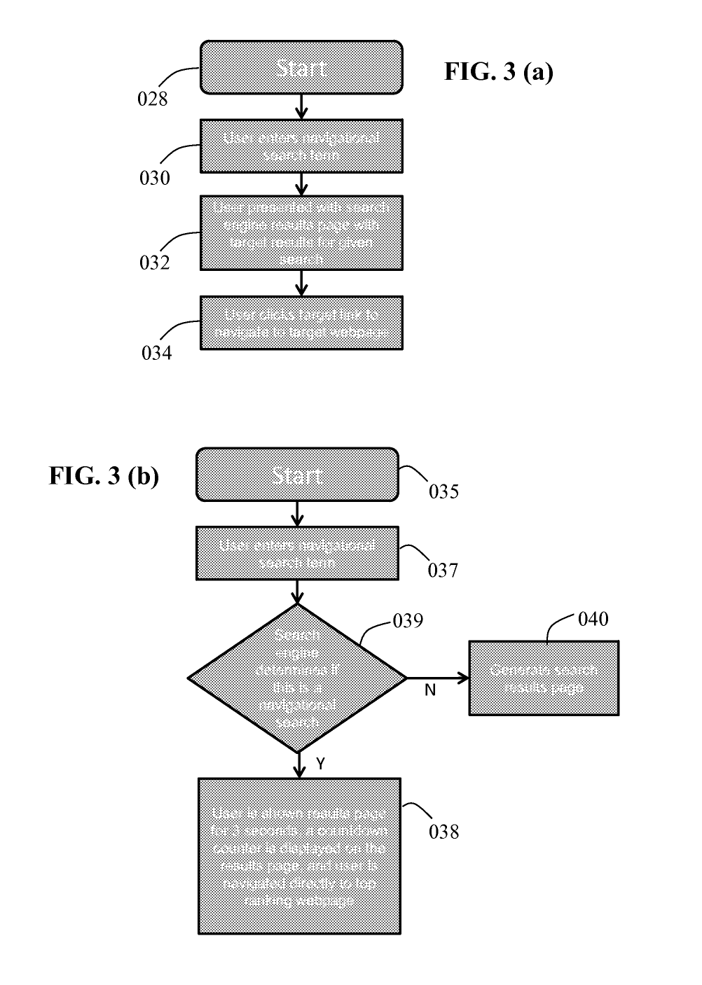

1. A system comprising a processor, a computer readable non-transitory storage medium for tangibly storing thereon program logic for execution by said processor, said program logic comprising:
a. a search query receiving logic executed by said processor for receiving a search query from a user over a computer network;
b. an algorithmic search logic executed by said processor for providing search results on a display to said user;
c. a search query classification logic executed by said processor which classifies said search query as a navigational search query or a non-navigational search query;
d. user redirection logic executed by said processor which redirects said user's browser application to highest ranking search result generated by said algorithmic search logic, without requiring any further input from said user, when said search query classification logic classifies said search query as a navigational search query.

2. A system of claim 1 wherein said user redirection logic executed by said processor initially displays search results generated by said algorithmic search logic to said user for a predetermined period of time, and then redirects said user's browser application to highest ranking search result generated by said algorithmic search logic, without requiring any further input from said user, when said search query classification logic classifies said search query as a navigational search query.

3. A system comprising a processor, a computer readable non-transitory storage medium for tangibly storing thereon program logic for execution by said processor, said program logic comprising:
a. a search query receiving logic executed by said processor for receiving a search query from a user over a computer network;
b. an algorithmic search results generation logic executed by said processor for generating search results;
c. a search engine results display logic which displays said search results from said algorithmic search results generation logic on the user's display;
d. a page metadata summary display logic which enables the display of a metadata summary user interface element on said user's display, on top of said search results, such that said metadata summary user interface element displays metadata about a search result chosen by said user.

4. The system of claim 3 wherein said metadata displayed by said metadata summary user interface element comprises of items selected from the group consisting of search term frequency and site type and unusual words and unusual phrases and similar phrases on page and definitions on page and major headings on page and major sites linking to said page and major sites linked to from said page and images on said page and tables on said page.

5. The system of claim 3 wherein said page metadata summary display logic analyses search engine results pages and extracts relevant metadata elements from said pages beforehand, and stores said metadata for said pages in a database, so when said search engine results are displayed to said user, the content of said metadata summary user interface element are already present in said database.

6. A system comprising a processor, a computer readable non-transitory storage medium for tangibly storing thereon program logic for execution by said processor, said program logic comprising:
a. a search query receiving logic executed by said processor for receiving a search query from a user over a computer network;
b. an algorithmic search results generation logic executed by said processor for providing search results generated algorithmically;
c. a search engine results display logic which displays said search results of said algorithmic search results generation logic on said user's display;
d. a page rankings summary display logic which makes possible the display of a rankings summary user interface element on said user's display, on top of said search engine results, such that said rankings summary user interface element displays rankings data about a search result chosen by said user.

7. The system of claim 6 wherein said contents displayed by said rankings summary user interface element comprises of items selected from the group consisting of keyword quality rankings and relevant text rankings and link quality rankings and freshness rankings and list of highest ranking keywords on a given page.

8. The system of claim 6 wherein said page rankings summary display logic analyses chosen pages and prepares relevant rankings data for said pages beforehand, and stores said rankings data for said pages in a database, so when said search results are displayed to said user, the content of said rankings summary user interface element are already present in said database.
